(19) United States
(12) Patent Application Publication
(10) Pub. No.: US 2026/0261484 A1
(43) Pub. Date: Sep. 3, 2026

(54) SYSTEMS AND METHODS FOR PREDICTING COMPUTER NETWORK OUTAGES

(71) Applicant: Capital One Services, LLC, McLean, VA (US)

(72) Inventors: Herbert SHIN, North Bergen, NJ (US); Troy KOSS, Tampa, FL (US); Michael GOINS, Allen, TX (US)

(73) Assignee: Capital One Services, LLC, McLean, VA (US)

(21) Appl. No.: 19/069,200

(22) Filed: Mar. 3, 2025

(51) Int. Cl. H04L 41/147; G06N 20/00; H04L 43/0817

(52) U.S. Cl. CPC H04L 41/147; G06N 20/00; H04L 43/0817

(57) ABSTRACT

Systems and methods for predicting network outages based on detected network-wide resilience. For example, the system may receive first computer network traffic data for a first time period and a second time period, wherein the first computer network traffic data for the first time period indicates a first load on a first computer network. The system may determine a first error resilience metric based on the first load. The system may determine a first error resilience rate-of-change for the first computer network based on the first error resilience metric. The system may determine a first likelihood of a first network outage based on comparing the first error resilience rate-of-change to the threshold error resilience metric.

### BACKGROUND

Recent technological advancements have significantly expanded the use of computer networks while simultaneously increasing the potential for network outages. The proliferation of cloud computing, IoT (Internet of Things) devices, and edge computing has driven the need for highly interconnected and complex networks to support seamless communication, data sharing, and real-time analytics. These innovations have enabled businesses and individuals to access services and resources from virtually anywhere, enhancing productivity and connectivity. However, the growing reliance on these networks has also amplified vulnerabilities. With the rise of cyberattacks, such as ransomware and distributed denial-of-service (DDoS) attacks, networks face heightened risks of downtime. Additionally, the increased complexity of network architectures, which integrate diverse devices and systems, makes them more susceptible to misconfigurations, software bugs, and hardware failures. Natural disasters and power outages can further exacerbate these risks, disrupting critical services. As technology evolves, maintaining the balance between innovation and robust network infrastructure becomes crucial to minimizing the impact of outages and ensuring reliable connectivity.

### SUMMARY

Despite the increased reliance on computer networks, predicting network outages can be challenging due to the complexity and scale of modern networks, as well as the variety of factors that can cause disruptions. Networks often span vast geographic areas, incorporate multiple interconnected devices, and rely on numerous service providers, making it difficult to pinpoint the exact source of a problem. Additionally, outages can result from diverse causes, such as hardware failures, software bugs, misconfigurations, cyberattacks, or external factors like weather events. Distinguishing between a minor performance degradation and a full outage can be particularly challenging, especially when monitoring tools are not synchronized or provide inconsistent data. Furthermore, many networks rely on redundant systems to ensure high availability, which can mask underlying issues until they escalate into larger problems. The increasing use of encrypted traffic and distributed systems, such as cloud-based services and IoT devices, adds another layer of complexity, as traditional monitoring tools may lack the visibility needed to detect issues effectively. As a result, detecting potential network outages remains technically challenging.

One solution for predicting network outages is to monitor each of the variety of factors for anomalies that could lead to a catastrophic network outage for characteristics of a network outage. However, monitoring the variety of factors for anomalies that could lead to a catastrophic network outage is technically difficult and often an unreliable predictor because of the complexity and unpredictability of modern networks. Networks comprise a vast array of interconnected components—servers, routers, switches, and endpoints—each with its own potential failure points. Additionally, external influences like cyberattacks, natural disasters, and human errors introduce variables that are challenging to foresee or quantify. While monitoring tools can track individual indicators such as bandwidth usage, latency, or hardware performance, these metrics do not always correlate directly to impending catastrophic failures. Many outages occur due to the simultaneous interaction of multiple, seemingly minor issues, which are difficult to detect in isolation or predict collectively. Moreover, the sheer volume of data generated by monitoring every potential factor can overwhelm analytics systems, leading to “noise” that obscures meaningful insights. False positives, where minor anomalies are flagged as critical, further reduce the reliability of predictions.

In contrast to an anomaly detection approach or an approach that attempts to directly predict a network outage, the systems and methods use an indirect approach by quantifying the overall error resilience in the network as a whole. For example, the systems and method may determine an “error budget” for a network and monitor a percentage of that budget that is remaining on a rolling basis. By monitoring the percentage budget remaining, the systems and methods may determine periods of time when catastrophic network outages are possible because the error resilience left in the network cannot absorb any anomalies in the variety of factors that could lead to a catastrophic network outage.

However, determining error resilience in a network as a whole is not always a reliable predictor of catastrophic network outages because error resilience metrics are inherently dynamic and influenced by fluctuating network usage. High-usage periods naturally push networks closer to their performance limits, which may trigger error resilience indicators to suggest a heightened risk of failure. Nonetheless, these instances of high use do not always result in actual outages, as modern networks are often designed with redundancies and scalability to handle spikes in demand. This fluctuation can lead to false alarms, where periods of intense activity are erroneously flagged as likely to fail, even though the network may continue to operate smoothly.

In view of this novel technical problem with using determined error resilience in a network to predict network outages, the systems and methods determine the rate of changes in the error resilience and compare these to historic patterns in rates-of-change for error resilience. For example, if high-usage periods are historically compensated for with increased error resilience due to redundancies and scalability, the systems and method account for this and do not predict false alarms. Instead, the systems and methods monitor for instances and/or patterns when usage and compensation in error resilience begin to stray outside historical normal. Notably, this is particularly beneficial for predicting catastrophic network outages due to “slow burn” in reduction to network error resilience. By detecting series of gradual declines in error resilience metrics, even if the series is interrupted by sudden spikes in resilience, the systems and methods may identify time periods with high potentials for catastrophic network outages. By doing so, the system and methods may predict network outages despite the challenges due to the complexity and scale of modern networks, as well as the variety of factors that can cause disruptions.

In some aspects, systems and methods for predicting network outages based on detected network-wide resilience are described. For example, the system may receive first computer network traffic data for a first time period and a second time period, wherein the first computer network traffic data for the first time period indicates a first load on a first computer network, and wherein the first computer network traffic data for the second time period indicates a second load on the first computer network. The system may determine a first error resilience metric based on the first load. The system may determine a second error resilience metric based on the second load. The system may determine a first error resilience rate-of-change for the first computer network based on the first error resilience metric and the second error resilience metric. The system may compare the first error resilience rate-of-change to a threshold error resilience metric. The system may determine a first likelihood of a first network outage based on comparing the first error resilience rate-of-change to the threshold error resilience metric. The system may generate for display, on a user interface, a prediction for the first network outage based on the first likelihood.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIGS. 1A-C show an illustrative diagram for determining error resilience metrics, in accordance with one or more embodiments.

FIG. 2 shows an illustrative diagram for pseudocode to determining error resilience metrics, in accordance with one or more embodiments.

FIG. 3 shows illustrative components for a system used to predict network outages, in accordance with one or more embodiments.

FIG. 4 shows a flowchart of the steps involved in predicting network outages, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

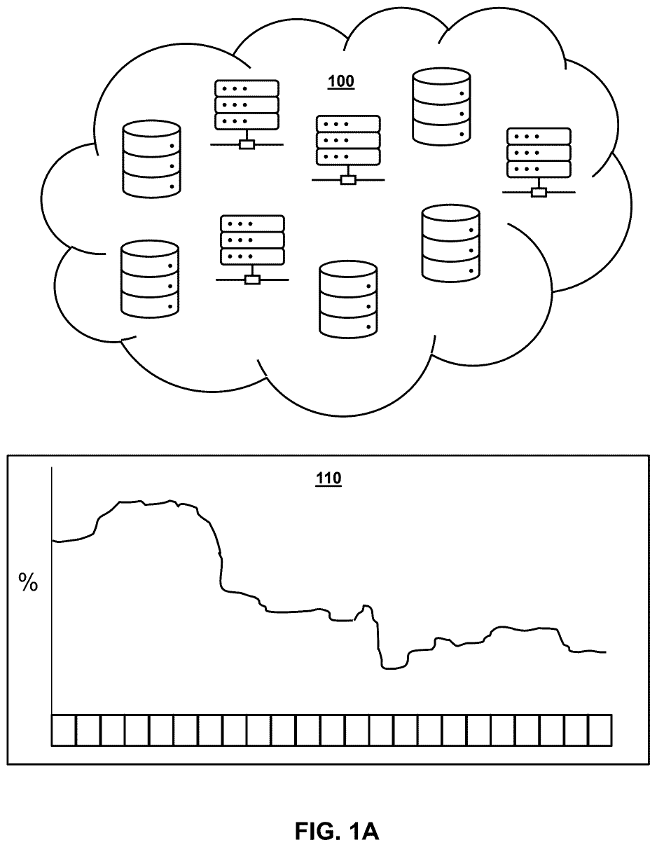

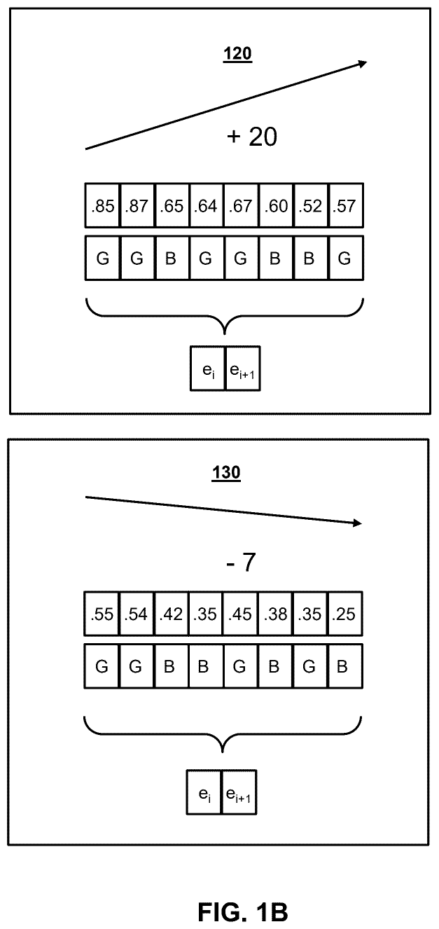

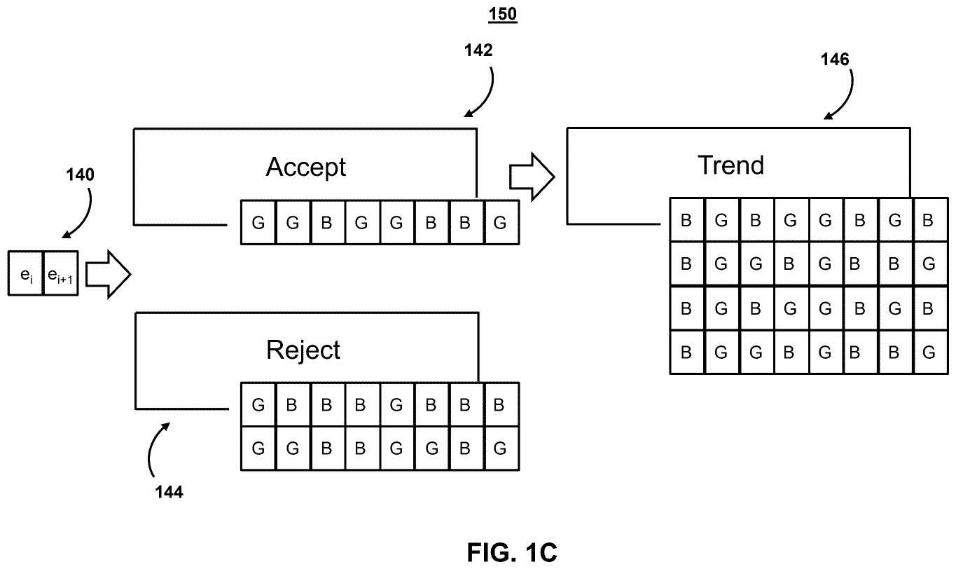

FIGS. 1A-C show an illustrative diagram for determining error resilience metrics, in accordance with one or more embodiments. For example, FIG. 1A shows computer network 100. As described herein, a computer network (e.g., computer network 100) may be a system that connects multiple devices to enable communication, data sharing, and resource access. These devices typically include computers, servers, printers, routers, switches, and various smart devices such as smartphones, IoT sensors, and tablets. The devices in a computer network are connected through a combination of wired connections, such as Ethernet cables, and wireless technologies like Wi-Fi or Bluetooth. At the core of the network, routers and switches manage data traffic, directing information between devices to ensure efficient and reliable communication. Computer networks can vary in size and complexity, ranging from small local area networks (LANs) within a home or office to large-scale wide area networks (WANs) that span cities, countries, or even the globe. The interconnected devices in a network communicate using standardized protocols, such as TCP/IP, which ensure compatibility and consistency across different types of hardware and software. These networks form the foundation of modern communication, powering everything from simple file sharing to global internet connectivity.

In some embodiments, computer network 100 may be a cloud computer network. A cloud computer network may be a virtualized network infrastructure that enables the delivery of computing resources and services over the internet, often referred to as “the cloud.” Unlike traditional physical networks, which rely on on-premises hardware, cloud networks operate through data centers managed by cloud service providers. These networks connect servers, storage systems, applications, and devices in a scalable and flexible way, allowing users to access resources on demand. Cloud computer networks are composed of virtual machines, containers, and software-defined networking (SDN) technologies that enable seamless communication and resource allocation. Users can connect to a cloud network through various devices, including computers, smartphones, and IoT devices, using an internet connection. The cloud network supports diverse applications, such as data storage, application hosting, machine learning, and collaboration tools.

In some embodiments, computer network 100 may be used by one or more users, applications, and/or services to perform one or more network operations. As described herein, a network operation may refer to the processes and/or activities involved in managing, monitoring, using, and/or maintaining a computer network to ensure its optimal performance, reliability, and security and/or perform one or more processing tasks.

For example, a network operation may comprise a processing task that involves the handling, transformation, or analysis of data as it moves across the network to achieve a specific purpose. One example is data packet routing, where the network processes incoming data packets to determine the most efficient path to their destination. This task requires analyzing the packet headers to identify source and destination addresses, applying routing protocols, and making real-time decisions based on network traffic and availability. Other processing tasks include load balancing, where the network distributes workloads across multiple servers to ensure optimal performance, and encryption or decryption, which secures data for transmission and access. In more advanced scenarios, processing tasks might include real-time data analytics, such as detecting anomalies in traffic patterns to prevent cyberattacks or enabling machine learning applications by distributing computational tasks across networked devices. These tasks are essential for ensuring the network operates efficiently, securely, and in alignment with user and organizational requirements.

In another example, a network operation may encompass tasks such as configuring network devices, monitoring traffic, usage patterns, troubleshooting connectivity issues, and/or implementing security measures to protect against threats. Network operations may also include the deployment of updates, patches, and upgrades to hardware and software components, ensuring that the network remains current and efficient. Additionally, they involve planning and executing changes to the network infrastructure, such as expanding capacity or integrating new technologies. Often managed through a Network Operations Center (NOC), these activities are supported by specialized tools and software that provide real-time visibility and analytics. Effective network operations are essential for sustaining uninterrupted communication, minimizing downtime, and enabling businesses and users to rely on their networks for critical tasks and services.

FIG. 1A also includes diagram 150. Diagram 150 may appear on a user interface. As referred to herein, a “user interface” may comprise a human-computer interaction and communication in a device, and may include display screens, keyboards, a mouse, and the appearance of a desktop. For example, a user interface may comprise a way a user interacts with an application or a website.

As referred to herein, “content” should be understood to mean an electronically consumable user asset, such as Internet content (e.g., streaming content, downloadable content, Webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices, but can also be part of a live performance. Furthermore, user generated content may include content created and/or consumed by a user. For example, user generated content may include content created by another, but consumed and/or published by the user.

The system may monitor content generated by the user to generate user profile data. As referred to herein, “a user profile” and/or “user profile data” may comprise data actively and/or passively collected about a user. For example, the user profile data may comprise content generated by the user and a user characteristic for the user. A user profile may be content consumed and/or created by a user.

User profile data may also include a user characteristic. As referred to herein, “a user characteristic” may include information about a user and/or information included in a directory of stored user settings, preferences, and information for the user. For example, a user profile may have the settings for the user's installed programs and operating system. In some embodiments, the user profile may be a visual display of personal data associated with a specific user, or a customized desktop environment. In some embodiments, the user profile may be a digital representation of a person's identity. The data in the user profile may be generated based on the system actively or passively monitoring.

An error resilience metric may be a quantitative measure of a computer network's ability to tolerate and recover from errors, disruptions, or additional loads while maintaining its performance and reliability. This metric reflects the network's capacity to handle unexpected demands, such as surges in traffic or the failure of components, without degrading service quality. It is typically based on factors such as available resources (e.g., bandwidth, processing power), redundancy, and error rates.

An error resilience rate-of-change may represent the speed and direction of changes in the network's error resilience over time. It quantifies how quickly the network's ability to recover from errors or adapt to additional loads is improving or declining. For example, a positive rate-of-change indicates that the network is becoming more resilient, while a negative rate-of-change suggests a reduction in resilience, which may signal potential vulnerabilities.

A network outage may be a period during which a computer network is unavailable or unable to perform its intended functions, resulting in disrupted communication, data flow, or service delivery. Outages can range from minor interruptions affecting specific devices to widespread failures impacting entire networks. They may result from various causes, including hardware or software failures, misconfigurations, cyberattacks, or external factors such as natural disasters. Understanding error resilience metrics and their rate-of-change can help predict and prevent network outages by identifying potential issues before they escalate into critical failures.

Diagram 110 may indicate an error resilience trend. For example, diagram 110 may indicate an amount of error resilience available to a computer network across a plurality of time periods. For example, the system may monitor network operations communicated between a first network device on a first computer network and a second network device on the first computer network over a first time period and a second time period. The system may then determine first computer network traffic data based on monitoring the network operations, wherein the first computer network traffic data for the first time period indicates a first load on a first computer network, wherein the first computer network traffic data for the second time period indicates a second load on the first computer network, wherein the first load corresponds to a first subset of the network operations processed during the first time period, and wherein the second load corresponds to a second subset of the network operations processed during the second time period.

To determine an amount of error resilience available to a computer network across multiple time periods, a system performs a series of monitoring and analytical steps. First, the system observes network operations occurring between devices within the network—such as between a first network device and a second network device—over specified time periods (e.g., a first time period and a second time period). During this monitoring, the system collects detailed data on network traffic, including the volume and type of operations processed, such as data transfers, requests, and responses.

Based on this monitoring, the system generates computer network traffic data for each time period. This traffic data quantifies the load on the network, with the “load” reflecting the number of operations or the volume of data being processed during a given time period. For instance, the first time period might correspond to a lower load (a smaller subset of network operations), while the second time period might involve a higher load (a larger subset of network operations).

The system then analyzes this traffic data to assess the network's error resilience, which refers to its capacity to handle additional load or recover from errors without degradation in performance. To do this, the system may factor in metrics such as latency, error rates, packet loss, and bandwidth usage. It may also evaluate how the network adapts to varying conditions, such as rerouting traffic during congestion or maintaining redundancy.

By comparing the network's performance and capacity across different time periods, the system identifies patterns or thresholds where the network begins to exhibit reduced resilience. This analysis helps determine the network's ability to sustain normal operations under varying loads and provides insights into its overall robustness and error tolerance. These findings can then guide optimizations, such as reallocating resources, enhancing redundancy, or implementing preventive measures to address potential vulnerabilities.

As described herein, a load on a computer network refers to the amount of data traffic or the number of operations being processed by the network at a given time. It represents the demand placed on the network's resources, such as bandwidth, processing power, and storage capacity, by devices and applications communicating over the network. Load can be influenced by various factors, including the number of active users, the type of data being transmitted (e.g., video streaming, file downloads, or simple text-based communication), and the frequency of network requests. High network load, such as during peak usage periods, can strain the network's infrastructure, potentially leading to slower response times, congestion, or even outages if the demand exceeds the network's capacity. Conversely, low network load typically indicates less demand and more available resources, allowing the network to operate with minimal latency and higher efficiency. Managing network load effectively is crucial for maintaining performance, ensuring quality of service (QoS), and preventing disruptions in communication or operations.

Network traffic data may refer to the information collected about the data packets transmitted across a computer network. This data provides insights into how the network is being used, including details such as the volume, type, and source/destination of traffic. Network traffic data typically includes metrics like packet size, bandwidth usage, transmission speed, latency, and error rates. It may also capture patterns of communication, such as which devices are interacting, the frequency of requests, and the protocols being used (e.g., HTTP, FTP, or TCP/IP). Analyzing network traffic data may be used for various purposes, including monitoring network performance, identifying bottlenecks, troubleshooting issues, and ensuring security. For instance, sudden spikes in traffic could indicate a surge in legitimate activity or a potential cyberattack, such as a distributed denial-of-service (DDoS) attack.

Diagram 110 may represent one or more error resilience metrics across a plurality of time periods. An error resilience metric may be based on a first amount of computer resources available for processing additional network operations through the first computer network beyond a current load. For example, an error resilience metric may indicate an amount of error budget remaining in the event that an additional load is introduced and/or the computer network loses one or more resources (e.g., a component used to provide the computer network). For example, an error resilience metric is a measure that indicates the ability of a computer network to tolerate and recover from errors, disruptions, or additional demands without compromising performance or functionality. This metric often may reflect the availability of surplus computing resources, such as processing power, memory, and bandwidth, that can be allocated to handle unexpected increases in network load or to compensate for the failure of one or more network components. For instance, an error resilience metric might reflect the “error budget” remaining in the network, which is the capacity to sustain additional operations or loads beyond the current usage level while maintaining reliability and service quality. This budget serves as a buffer against potential disruptions, allowing the network to adapt to sudden changes, such as surges in traffic or hardware failures. By evaluating error resilience metrics, network administrators can identify potential vulnerabilities, plan for contingencies, and ensure the network remains robust under varying conditions, contributing to improved stability and performance.

For example, to determine the rate of changes in error resilience and compare these to historical patterns, a system leverages advanced monitoring, analytics, and predictive modeling techniques. The process begins by continuously measuring error resilience metrics over time, capturing data on the network's available resources, load, redundancy, and performance. These metrics are analyzed to calculate the rate at which error resilience increases or decreases, particularly in response to variations in network usage or environmental factors. The system then compares these rates of change to historical patterns, which serve as a baseline for normal network behavior. For example, during high-usage periods, historical data may show that the network typically compensates for increased demand by utilizing redundant resources or scaling up capacity. Deviations from this normal pattern—such as slower-than-expected recovery, sustained reductions in resilience, or inconsistent compensation—are flagged as anomalies. These anomalies may indicate underlying issues, such as failing components, resource depletion, or misconfigurations.

By detecting gradual, long-term declines in error resilience (“slow burns”), even when interspersed with temporary recoveries, the system can identify potential precursors to catastrophic network outages. Such declines may reflect hidden vulnerabilities or inefficiencies that could escalate under continued stress. This method allows the system to differentiate between normal fluctuations and problematic trends, reducing false alarms and enhancing its ability to predict outages accurately. By combining real-time monitoring with historical analysis and pattern recognition, the system can account for the complexity and scale of modern networks. It provides a proactive approach to network management, enabling operators to address issues before they culminate in widespread disruptions, thus improving reliability and minimizing downtime.

For example, FIG. 1B shows determining a first error resilience (e.g., error resilience 120) and a second error resilience (e.g., error resilience 130). Each error resilience comprises a subset of time periods (e.g., eᵢ through eᵢ₊₁) as well as a corresponding rate-of-change for the time period. For example, the system may use events in a time period (start time, tₒ, and end time, t_{f}) to analyze and identify trends. An event may be a scalar value of a system's state-like a network latency metric (e.g., 100 ms) or HTTP status code (e.g., 404) sent back by the server.

The system may normalize each event value to a comparable state of boolean true (“Good”) or false (“Bad”). For example, 100 ms passed through a logical check, f(x)=x<200 ms to yield a ‘true’. The system may determine f(x) based on the requirements of the end users based on their business requirements (e.g., a service level objective).

For example, the system may determine an error resilience maximum corresponding to a total allowable error between (start time, tₒ, and end time, t_{f}). The system may calculate this based on:

$$Error Budget Max TW = ( 1 - Service Level Objective ) * Total EventsTW$$

For example, if a service level objective of 99.99% with 100, 000, 000 events in 30 days, the system calculates the error resilience maximum based on:

$$Error Budget Max = ( 1 - 0.9999 ) * 100 , 000 , 000 = 10 , 0.$$

Or only 10, 000 errors should be allowed during the observed 30 days.

Additionally, the system may generate a burnrate. For example, the system may calculate the burn rate coefficient of the normalized events (adjacent events). The system may determine the proportion of the consumed Error Budgets over the allowed error max value. For example, high value (BurnRate>1) indicates rapid burn-throughs. Equal value (BurnRate=1) may indicate the Error Budget has been exhausted and remains there. Low value (BurnRate<1) indicates the Error Budget has begun to recover as “Bad” events have been diminished. For example, the system may calculate the burnrate as:

$$Burn {Rate}_{SW} = Bad {Events}_{SW} / Error Budget Max$$

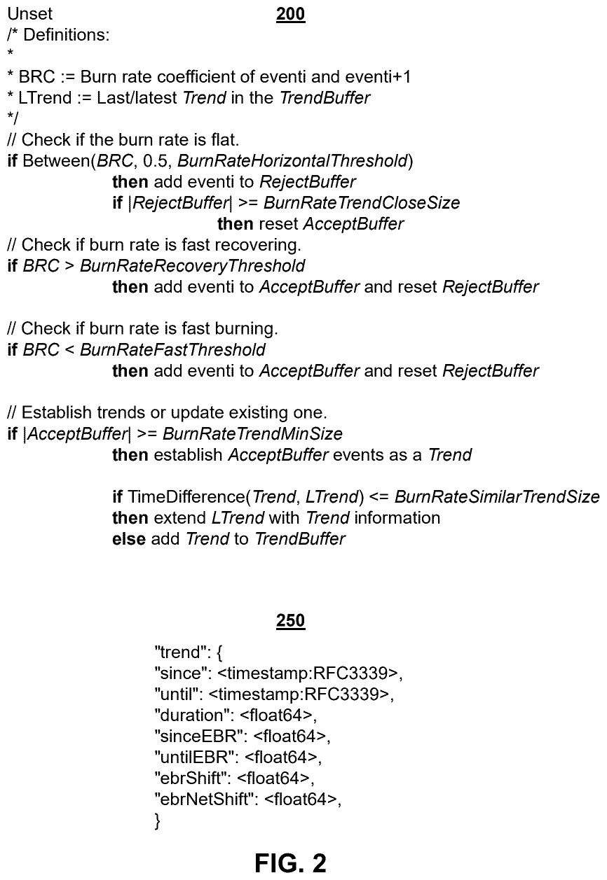

The system may use these determinations to generate trends (e.g., as shown in the pseudocode of FIG. 2 below). Additionally, the system may generate an aggregated trend based on the directions each trend is pointing TrendBuffer to (up or down). For example, the first error resilience (e.g., error resilience 120) points up, and the second error resilience (e.g., error resilience 130) points down.

To determine an aggregated trend, the system may use:

$$Is Same Direction {( Trend}_{i} , {Trendi}_{+ 1} ) = ( {Trend}_{i} * {Trend}_{i + 1} ) > 0$$

For example, Trend A may indicate recovery of Error Budget by 20% and Trend B by −7%. The IsSameDirection(Trend_{A}, Trend_{B}) condition is not true, which verifies that Trend_{A} and Trend_{B} are opposite. If the IsSameDirection condition is satisfied, the two adjacent trends are merged together to form a single, larger trend. For example, the system determines does this to reduce smaller trend segments.

FIG. 1C shows a model architecture for detecting these trends. For example, diagram 150 shows the use of error resilience rate-of-change for determining trends. In some embodiments, the system may determine a first error resilience rate-of-change for the first computer network by determining a first error resilience metric (e.g., metric 140) based on the first load for a first time period, determining a second error resilience metric based on the second load for a second time period, and determining a third error resilience metric based on a third load for a third time period. The system may accept the first error resilience metric (e.g., add to cluster 142) and the second error resilience metric for use in determining a first trend (e.g., via cluster 146). The system may reject the third error resilience metric (e.g., add to cluster 144) for use in determining the first trend. The system may use the first trend to determine the first error resilience rate-of-change.

For example, the system may determine a first error resilience rate-of-change for a computer network by calculating error resilience metrics for different time periods and analyzing their trends. To start, the system determines a first error resilience metric based on the network's first load during a specified first time period, capturing how well the network could handle additional operations or recover from errors at that time. Similarly, it calculates a second error resilience metric for a second load observed during a second time period. These metrics provide snapshots of the network's resilience under varying conditions. The system may also calculate a third error resilience metric based on a third load during a third time period, but it evaluates each metric's relevance to the overall trend.

The system then examines the relationships between these metrics to establish a first trend that reflects the network's error resilience behavior over time. It may accept the first and second error resilience metrics for use in defining this trend if they align with historical patterns or provide meaningful data about the network's behavior. However, it may reject the third error resilience metric if it is deemed anomalous, inconsistent, or irrelevant to the trend, such as if the third load reflects atypical conditions or outliers that do not represent normal network operations.

Using the accepted metrics, the system defines the first trend and calculates the first error resilience rate-of-change. This rate-of-change quantifies how quickly the network's ability to handle errors and additional loads is improving or deteriorating over the analyzed periods. By focusing on meaningful metrics and excluding irrelevant ones, the system ensures accurate trend analysis, enabling better prediction and management of potential network vulnerabilities or outages. The system may then use this trend to predict network outages.

FIG. 2 shows an illustrative diagram for pseudocode to determine error resilience metrics, in accordance with one or more embodiments. For example, pseudocode 200 may include code used to determine and/or use variables and constants. For example, constants may include BurnRateHorizontalThreshold, BurnRateTrendCloseSize, BurnRateRecoveryThreshold, BurnRateFastThreshold, BurnRateTrendMinSize, and BurnRateSimilarTrendSize are predefined constants. For example, a system using pseudocode 200 can incorporate variables and predefined constants to monitor and evaluate error resilience trends for predicting network outages. In this pseudocode, constants such as BurnRateHorizontalThreshold, BurnRateTrendCloseSize, BurnRateRecoveryThreshold, BurnRateFastThreshold, BurnRateTrendMinSize, and BurnRateSimilarTrendSize provide fixed reference values that define thresholds, patterns, and tolerances for analyzing error resilience metrics. For example, BurnRateHorizontalThreshold might represent a baseline rate of change in error resilience that is considered good, while BurnRateFastThreshold could specify a threshold for rapid declines in resilience that may indicate an emerging issue. Variables within the pseudocode would dynamically capture real-time data, such as the current error resilience (CurrentResilience), the rate of change in resilience (BurnRate), and historical patterns or trends (TrendData). The pseudocode would compare these variables against the predefined constants to identify anomalies. For instance, if the system detects a BurnRate exceeding the BurnRateFastThreshold or observes prolonged deviations below the BurnRateRecoveryThreshold, it might flag the situation as requiring further analysis or intervention.

The system could also analyze trend patterns using constants like BurnRateTrendCloseSize to determine how closely recent data aligns with historical trends and BurnRateSimilarTrendSize to assess the similarity of a current trend to known problematic patterns. By defining a minimum trend size with BurnRateTrendMinSize, the system ensures that only significant and sustained deviations are considered, avoiding false positives due to short-term fluctuations. This combination of predefined constants and dynamically updated variables allows the pseudocode to provide a structured, flexible framework for monitoring and predicting network resilience issues, enabling proactive responses to potential outages.

FIG. 2 also includes pseudocode 250, which may be used to determine a trend. For example, pseudocode 250 may include functions such as “trend”: {“since”: <timestamp:RFC3339>, “until”: <timestamp:RFC 822 or RFC 850>, “duration”: <float64>, “sinceEBR”: <float64>, “untilEBR”: <float64>, “ebrShift”: <float64>, “ebrNetShift”: <float64>,}. For example, the system may use pseudocode 250 with functions such as “trend” to monitor and analyze the progression of network error resilience over specific time intervals. The trend function encapsulates key data points that describe how error budget ratios (EBR) have evolved between two timestamps, denoted as since and until. The duration field provides the length of the observed period in seconds, offering context about whether changes occurred over a short or extended timeframe. By tracking the error budget ratio at the start (sinceEBR) and end (untilEBR) of the period, the system can calculate the absolute change (ebrShift) to determine how resilience has increased or decreased. Additionally, the ebrNetShift field captures a normalized or cumulative measure of the change, providing a deeper understanding of the overall impact on the network's capacity to handle additional load or recover from errors.

The system uses these metrics to identify trends, such as gradual declines in error resilience or sharp shifts that may indicate emerging issues. By comparing the trend data across multiple intervals, the system can detect deviations from historical patterns, allowing it to differentiate normal fluctuations from potential precursors to network outages. For example, a significant negative ebrShift over a long duration might signal a “slow burn” in resilience, while rapid declines within shorter periods may indicate immediate risks. Based on these insights, the system can trigger alerts, adjust network configurations, or allocate resources proactively to maintain stability. The structured approach of the trend function ensures precise monitoring and predictive capabilities, enabling the system to address network vulnerabilities effectively.

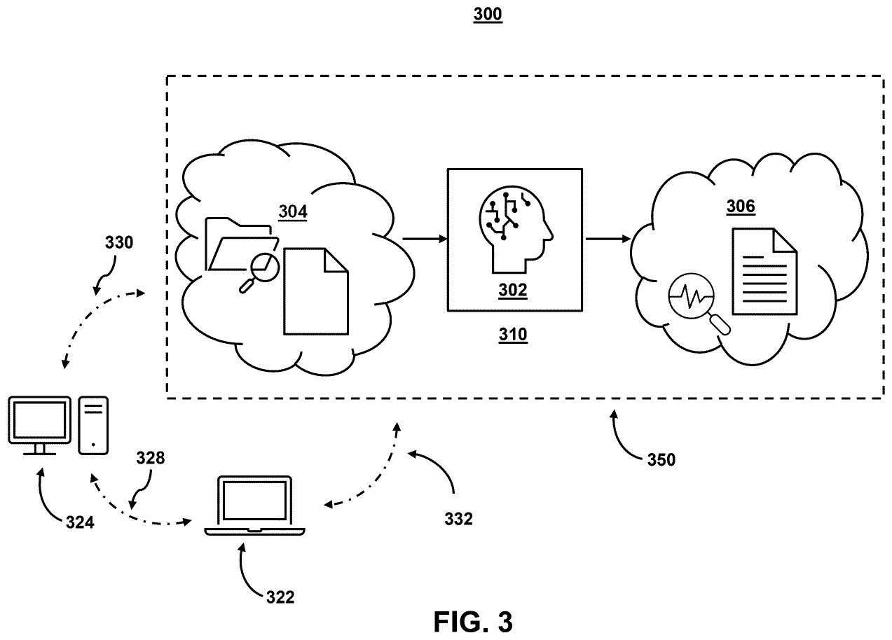

FIG. 3 shows illustrative components for a system used to predict network outages, in accordance with one or more embodiments. For example, FIG. 3 may show illustrative components for predicting network outages based on detected network-wide resilience. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically store information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

In some embodiments, system 300 and/or one or more models herein may be implemented using an application specific integrated circuit. An integrated circuit may be a small electronic device made of semiconductor material, typically silicon, that contains a large number of microscopic electronic components such as transistors, resistors, capacitors, and diodes. These components are interconnected to perform a specific function or set of functions. Integrated circuits can be classified into various types based on their functionality, such as analog, digital, and mixed-signal ICs. The transistors within an IC are the primary building blocks, as they act as switches or amplifiers for electronic signals. The other components, like resistors and capacitors, are used for controlling voltage, current, and timing within the circuit. System 300 may design the integrated circuit to be application specific such that design of the circuit is customized for a given application. In some embodiments, system 300 may use an integrated circuit system where one or more integrated circuits are spread throughout a system, network, and/or one or more devices. In such a case, the system design may ensure that the circuits are integrated with other electronic components like connectors, power supplies, and sensors to form a complete and functional electronic system. This integration allows for the implementation of sophisticated tasks in devices needed for one or more specified applications.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred to collectively as “models” herein). In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality can be complex and time-consuming. Additionally, data that is obtained may need to be categorized and labeled accurately, which can be difficult, time-consuming, and a manual task. Second, despite the mainstream popularity of artificial intelligence, practical implementations of artificial intelligence may require specialized knowledge to design, program, and integrate artificial intelligence-based solutions, which can limit the amount of people and resources available to create these practical implementations. Finally, results based on artificial intelligence can be difficult to review as the process by which the results are made may be unknown or obscured. This obscurity can create hurdles for identifying errors in the results, as well as improving the models providing the results.

Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., an error resilience metric, an error resilience rate-of-change, a network outage, etc.).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, backpropagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., an error resilience metric, an error resilience rate-of-change, a network outage, etc.).

In some embodiments, the model (e.g., model 302) may automatically perform actions based on outputs 306. In some embodiments, the model (e.g., model 302) may not perform any actions. The output of the model (e.g., model 302) may be used to predict network outages. In some embodiments, the system may generate predictions related to financial services. For example, the system may use one or more models and/or applications to process a variety of data to generate predictions for tasks such as payment card eligibility determinations, fraud detection, and/or determining rates for auto-finance applications. For credit card eligibility, the model may use data such as the applicant's credit score, income, employment history, debt-to-income ratio, and past credit history. This data helps the model predict the likelihood of the applicant repaying the credit card debt. For fraud detection, models analyze transaction data, including the amount, location, frequency, and pattern of transactions. They compare these patterns to known fraudulent behavior to identify potentially fraudulent activities. For determining auto-finance rates, models might use the applicant's credit score, loan amount, loan term, vehicle details, and market interest rates. The data used by these models comes from various sources, including credit bureaus, financial institutions, customer-provided information, transaction records, and public records. By analyzing these data points, models can make informed predictions and decisions that help financial institutions manage risk, provide appropriate services, and enhance customer satisfaction.

In some embodiments, the model may process received data through several stages. For example, the model may collect and aggregate data from various sources (e.g., a user account, industry data, third-party data sources, etc.). The system may ensure the data is cleaned and preprocessed to handle any missing and/or inconsistent information. This preprocessing may include normalizing numerical data, encoding categorical variables, and applying techniques to handle outliers. The model may then use feature engineering to identify and create relevant features that can improve its predictive power. For instance, the system may derive new variables from existing ones, such as calculating the debt-to-income ratio from debt and income data.

Once the data is prepared, the system feeds the data into the model, which could be an artificial intelligence algorithm such as logistic regression, decision trees, and/or neural networks. The model may be trained on historical data, learning patterns, and/or relationships between input features and the target outcomes. During this training process, the system may adjust the model parameters to minimize prediction errors. After training, the system may validate the model and test the model using separate data sets to ensure the model has a predetermined and/or threshold accuracy and generalizability.

In some embodiments, the system may use specialized predictions based on the task. Additionally or alternatively, the system may adjust the inputs and/or outputs based on the determinations and/or predictions required. For example, for credit card eligibility, the model may evaluate the applicant's likelihood of defaulting on payments. In fraud detection, the model may identify anomalies and patterns indicative of fraudulent behavior. In auto-finance rate determination, the model may predict the risk associated with lending to an individual and adjust the interest rates accordingly. In some embodiments, the entire process may be iterative, with models continually updated and refined as new data becomes available, ensuring they remain effective in making accurate and reliable predictions.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of their operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as a standard for external integration.

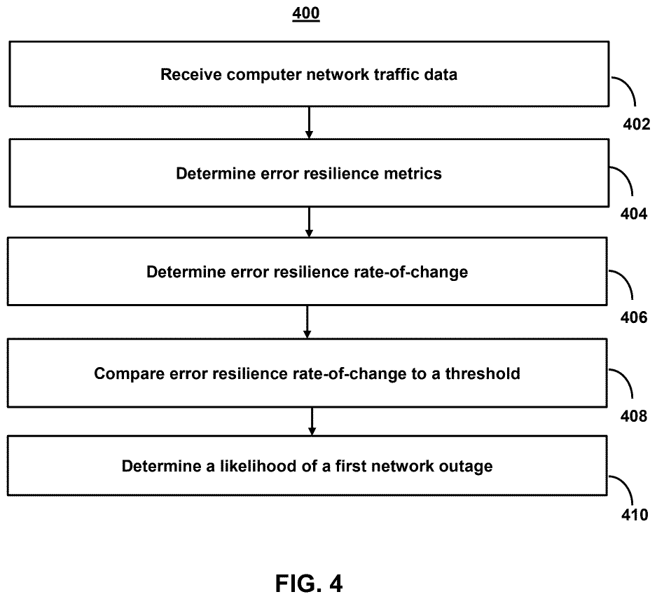

FIG. 4 shows a flowchart of the steps involved in predicting network outages, in accordance with one or more embodiments. For example, the system may use process 400 (e.g., as implemented on one or more system components described above) in order to predict network outages based on detected network-wide resilience.

At step 402, process 400 (e.g., using one or more components described above) receives computer network traffic data. For example, the system may receive first computer network traffic data for a first time period and a second time period, wherein the first computer network traffic data for the first time period indicates a first load on a first computer network, and wherein the first computer network traffic data for the second time period indicates a second load on the first computer network. The system may receive computer network traffic data through monitoring tools and technologies integrated into the network infrastructure. These tools capture real-time data about the flow of information across the network, including details about the volume, type, and source of traffic. For example, during a first time period, the system collects data reflecting a first load on the network, which may include metrics such as the number of active connections, bandwidth usage, and data packet flow rates. Similarly, for a second time period, the system gathers traffic data indicating a second load, providing a snapshot of the network's activity and resource utilization at that time. This data is typically transmitted to the system from devices such as routers, switches, firewalls, and network monitoring software through standardized protocols (e.g., SNMP, NetFlow, or sFlow). The collected traffic data allows the system to compare network performance across different time periods, identifying patterns or anomalies that could impact network resilience. By analyzing this information, the system can assess load variations and their effects on the network's capacity to handle additional operations, contributing to a comprehensive understanding of the network's behavior over time.

At step 404, process 400 (e.g., using one or more components described above) determines error resilience metrics. For example, the system may determine a first error resilience metric based on the first load and a second error resilience metric based on the second load. The system may determine error resilience metrics by analyzing the relationship between network load and the available capacity to handle additional operations or recover from errors during specific time periods. For example, the system may calculate a first error resilience metric based on the first load observed on the network during a given time period. This involves assessing key factors such as bandwidth utilization, processing power, redundancy, and error rates to quantify the network's ability to tolerate disruptions or handle increased demands. Similarly, the system calculates a second error resilience metric using the second load observed during a subsequent time period. The error resilience metric reflects the network's buffer or margin for accommodating additional operations without performance degradation. By comparing the first and second metrics, the system can identify trends or changes in the network's resilience over time. For instance, a decrease in the error resilience metric might indicate growing strain on the network due to higher loads or reduced redundancy. These metrics are essential for monitoring network health, predicting potential vulnerabilities, and ensuring that resources are allocated effectively to maintain stability and reliability.

In some embodiments, the system may determine the first error resilience metric based on computer resources available to process network operations through the first computer network. For example, the system determines the first error resilience metric by analyzing both the current load on the first computer network and the available computer resources that can be utilized to process additional network operations. This metric quantifies the network's capacity to handle disruptions, additional demands, or errors without a degradation in performance. The system begins by measuring the current load, which includes the volume of traffic, active connections, and the types of operations being processed. It then evaluates the available computer resources, such as unused bandwidth, processing power, memory, and redundancy mechanisms, that can be leveraged to absorb additional load or recover from potential failures. By combining these two factors—current load and available resources—the system calculates the first error resilience metric, which reflects the network's margin for handling unexpected challenges. For example, if the current load is low and ample resources are available, the error resilience metric would indicate high resilience. Conversely, if the network is operating near capacity with limited available resources, the metric would reflect lower resilience. This approach provides a comprehensive view of the network's operational stability, enabling the system to assess its ability to sustain performance under changing conditions and to identify potential vulnerabilities early.

In some embodiments, the system may determine a threshold error resilience metric by receiving historical computer network traffic data, determining respective historical error resilience metrics for each of a plurality of historical time periods, wherein each of the respective historical error resilience metrics comprises a respective percentage of network resources available for additional network traffic, determining historical rate-of-changes in the respective historical error resilience metrics over each of the plurality of historical time periods, and determining threshold error resilience metrics corresponding to a given error resilience metric and a given rate-of-change in the given error resilience metric. For example, the system may determine a threshold error resilience metric by leveraging historical computer network traffic data and analyzing patterns in network performance over time. First, the system receives historical traffic data corresponding to a plurality of historical time periods, capturing details about network loads and resource usage during those times. For each time period, the system calculates a respective historical error resilience metric, which represents the percentage of network resources that were available for handling additional traffic or recovering from disruptions. These metrics provide a baseline understanding of the network's capacity under varying conditions. Next, the system calculates historical rates-of-change in the respective error resilience metrics over the same time periods. These rates-of-change quantify how quickly the network's resilience improved or deteriorated, offering insights into the network's dynamic behavior. By correlating historical error resilience metrics with their rates-of-change, the system identifies trends and thresholds that distinguish normal fluctuations from conditions that led to or preceded network vulnerabilities or outages. Using this analysis, the system determines threshold error resilience metrics corresponding to specific error resilience values and their associated rates-of-change. These thresholds act as benchmarks for evaluating current and future network performance. For example, if historical data shows that a rapid decline in resilience combined with low available resources consistently led to outages, the system sets a threshold to flag similar conditions in real time. These thresholds enable proactive monitoring, allowing the system to predict potential issues and guide preventive actions to maintain network stability and reliability.

In some embodiments, the system may determine the first error resilience metric based on the first load by determining an amount of excess computer resources available to process network operations through the first computer network, determining a percentage of a total amount of computer resources in the first computer network corresponding to the amount of excess computer resources available to process network operations through the first computer network, and determining the first error resilience metric based on the percentage. For example, the system may determine the first error resilience metric based on the first load by evaluating the network's capacity to handle additional operations beyond its current usage. To start, the system calculates the amount of excess computer resources available to process additional network operations. These resources may include unused bandwidth, processing power, memory, and redundancy mechanisms within the first computer network that are not currently utilized for handling the first load. Next, the system determines the percentage of the total computer resources in the network that corresponds to this excess capacity. This is done by dividing the amount of excess resources by the total available resources in the network and expressing the result as a percentage. This percentage quantifies the network's spare capacity relative to its overall capability, providing a measure of its ability to absorb unexpected loads or recover from disruptions. Finally, the system uses this percentage to determine the first error resilience metric, which reflects the network's readiness to manage additional demands or errors. A higher percentage indicates greater resilience, while a lower percentage suggests the network is nearing its capacity, potentially increasing vulnerability to failures. By basing the error resilience metric on both the current load and available resources, the system provides a comprehensive and dynamic measure of the network's operational stability and ability to withstand changes or disruptions.

In some embodiments, the system may determine the first likelihood of the first network outage based on comparing the first error resilience rate-of-change to the threshold error resilience metric by determining a difference in time between the second error resilience metric and the threshold error resilience metric based on the first error resilience rate-of-change and using the difference in time to determine the first likelihood. For example, the system may determine the first likelihood of a network outage by analyzing the time it would take for the error resilience metric to reach a critical threshold, based on the observed error resilience rate-of-change. To do this, the system first calculates the first error resilience rate-of-change by assessing how quickly the network's resilience is declining between two measured metrics, such as the first and second error resilience metrics. It then determines the difference between the second error resilience metric and the threshold error resilience metric, which represents the gap between the current resilience level and the critical level at which the network may fail. Using the calculated rate-of-change, the system estimates the time required for the resilience metric to reach the threshold. This is achieved by dividing the difference in resilience by the rate-of-change, yielding the time interval during which the threshold would be breached if the current trend continues. The system interprets this “time-to-threshold” value to determine the first likelihood of a network outage: shorter time intervals indicate an imminent risk and correspond to a higher likelihood, while longer intervals suggest a lower likelihood of immediate failure. By incorporating this analysis, the system can provide a dynamic and predictive assessment of network stability. The calculated likelihood enables proactive responses, such as reallocating resources, addressing vulnerabilities, or implementing contingency plans to prevent the outage and maintain uninterrupted network operations.

In some embodiments, the system may determine the first likelihood of the first network outage based on comparing the first error resilience rate-of-change to the threshold error resilience metric by determining a difference in time between the first time period, corresponding to the first error resilience metric, and the second time period, corresponding to the second error resilience metric and using the difference in time to determine the first likelihood. For example, the system may determine the first likelihood of a network outage by analyzing the relationship between the time difference between two time periods and the rate at which error resilience is changing relative to a threshold. To do this, the system identifies the first time period corresponding to the first error resilience metric and the second time period corresponding to the second error resilience metric. It calculates the time difference between these periods, which reflects the duration over which the observed change in error resilience has occurred. Next, the system combines this time difference with the first error resilience rate-of-change, which quantifies how quickly the network's resilience is declining or improving over the observed time interval. By assessing the time difference in the context of the rate-of-change, the system estimates the proximity of the error resilience metric to the threshold value that indicates a critical risk level. For instance, if the time difference is short and the rate-of-change is steep, the system determines that the resilience metric is approaching the threshold rapidly, assigning a higher likelihood to the occurrence of a network outage. The system uses this analysis to produce a likelihood score that reflects the urgency and severity of the risk. Short time intervals coupled with significant declines in resilience indicate an imminent outage, while longer intervals or slower changes in resilience suggest a lower risk. This approach enables the system to dynamically evaluate and predict network stability, providing actionable insights for proactive network management and outage prevention.

At step 406, process 400 (e.g., using one or more components described above) determines the error resilience rate-of-change. For example, the system may determine a first error resilience rate-of-change for the first computer network based on the first error resilience metric and the second error resilience metric. The system may determine an error resilience rate-of-change by analyzing how error resilience metrics evolve over time, providing a measure of how quickly the network's ability to tolerate errors or handle additional loads is changing. For example, the system may calculate a first error resilience rate-of-change for the first computer network by comparing the first error resilience metric, which reflects the network's resilience during a first time period, with the second error resilience metric, representing resilience during a subsequent time period. The rate-of-change is determined by taking the difference between the two metrics and dividing it by the time elapsed between the two periods. This calculation provides insight into whether the network's resilience is improving or deteriorating and at what speed. A positive rate-of-change indicates that the network is becoming more robust, potentially due to increased redundancy or reduced load. Conversely, a negative rate-of-change suggests declining resilience, which could signal issues such as resource depletion, increased traffic, or failing components. By monitoring and analyzing these changes over time, the system can identify trends, detect early warning signs of potential vulnerabilities, and help administrators implement proactive measures to prevent outages or performance degradation.

In some embodiments, the system may determine the first error resilience rate-of-change for the first computer network based on the first error resilience metric and the second error resilience metric by determining a first component rate-of-change for the first time period, determining the first error resilience metric based on the first component rate-of-change, determining a second component rate-of-change for the second time period, determining the second error resilience metric based on the second component rate-of-change, determining an aggregate rate-of-change based on the first component rate-of-change and the second component rate-of-change, and using the aggregate rate-of-change to determine the first error resilience rate-of-change. For example, the system may determine the first error resilience rate-of-change for a computer network by combining component rate-of-change calculations for multiple time periods into an aggregate measure. First, the system calculates a first component rate-of-change for the network during the first time period. This involves analyzing changes in factors influencing the error resilience metric, such as available resources, current load, and performance trends. Using this component rate-of-change, the system determines the first error resilience metric, representing the network's capacity to handle additional operations or recover from errors during that time period. Similarly, the system calculates a second component rate-of-change for the second time period by evaluating how the network's conditions evolved during that interval. This component rate-of-change is then used to determine the second error resilience metric, providing an updated measure of the network's resilience. To assess the overall trend in network resilience, the system calculates an aggregate rate-of-change by combining the first and second component rate-of-change values. This aggregate rate-of-change captures the combined effect of changes across both time periods, offering a more comprehensive view of how the network's resilience is evolving. Finally, the system uses this aggregate rate-of-change to determine the first error resilience rate-of-change, which reflects the network's overall trajectory in its ability to manage errors and additional loads over the observed intervals. This approach ensures that the system accounts for variations in resilience behavior across different time periods and provides a reliable measure of how quickly the network's error tolerance is changing, enabling accurate predictions and informed decision-making for maintaining network stability.

In some embodiments, the system may determine the first error resilience rate-of-change for the first computer network based on the first error resilience metric and the second error resilience metric by determining a third error resilience metric based on a third load for a third time period, accepting the first error resilience metric and the second error resilience metric for use in determining a first trend, rejecting the third error resilience metric for use in determining the first trend, and using the first trend to determine the first error resilience rate-of-change. For example, the system may determine the first error resilience rate-of-change for a computer network by analyzing valid error resilience metrics and filtering out anomalies to establish a reliable trend. The process begins with the system calculating a third error resilience metric based on the network's conditions under a third load during a third time period. It also identifies the first error resilience metric and the second error resilience metric, which correspond to network loads during the first and second time periods, respectively. The system evaluates these three metrics to determine their relevance for defining a trend that represents the network's error resilience behavior. It accepts the first and second error resilience metrics for use in establishing the first trend because they align with expected patterns or fall within a range of normalcy based on historical data and network conditions. Conversely, the system rejects the third error resilience metric for use in the trend if it identifies this metric as an outlier—such as if it reflects an atypical condition, anomaly, or isolated spike in network load that does not represent the network's typical behavior. Using the accepted metrics, the system calculates a first trend that represents the change in error resilience over the first and second time periods. This trend captures the relationship between the metrics, accounting for the rate and direction of change in the network's ability to handle additional loads or recover from errors. Finally, the system uses this first trend to determine the first error resilience rate-of-change, which quantifies the overall change in resilience across the observed periods. By filtering out irrelevant metrics and focusing on valid data, the system ensures the accuracy and reliability of its resilience rate-of-change calculations, enabling effective monitoring and proactive management of network stability.

At step 408, process 400 (e.g., using one or more components described above) compares error resilience rate-of-change to a threshold. For example, the system may compare the first error resilience rate-of-change to a threshold error resilience metric. The system may compare an error resilience rate-of-change to a threshold by evaluating whether the observed changes in network resilience fall within acceptable limits or indicate potential problems. For example, after calculating the first error resilience rate-of-change, which measures how quickly the network's error tolerance is improving or deteriorating over time, the system compares this value to a predefined threshold error resilience metric. This threshold serves as a benchmark, representing the maximum acceptable rate of decline or the minimum required rate of improvement in resilience to ensure stable network operations. If the first error resilience rate-of-change exceeds the threshold in a negative direction (indicating a rapid decline), the system may flag the situation as a warning or potential risk. Conversely, if the rate-of-change remains within the acceptable range or shows improvement, the system considers the network to be operating within safe parameters. This comparison allows the system to differentiate between normal fluctuations and significant deviations that could lead to network instability or outages. By continuously monitoring and comparing rate-of-change values against thresholds, the system can proactively identify and address potential vulnerabilities, ensuring the network remains resilient and reliable.

In some embodiments, the system may compare the first error resilience rate-of-change to the threshold error resilience metric by determining a threshold error resilience rate-of-change corresponding to the threshold error resilience metric and using the threshold error resilience rate-of-change to compare to the first error resilience rate-of-change. For example, the system may compare the first error resilience rate-of-change to a threshold error resilience metric by deriving a corresponding threshold error resilience rate-of-change and using it as a benchmark. The process begins by analyzing the threshold error resilience metric, which represents the critical level of error resilience below which network stability may be compromised. Based on this metric, the system calculates the threshold error resilience rate-of-change, which reflects the maximum acceptable speed at which the network's error resilience can decline without reaching the threshold too rapidly. This rate is derived by considering historical trends, typical network behavior, and the time available for corrective actions before the threshold is breached. Once the threshold error resilience rate-of-change is established, the system compares it to the first error resilience rate-of-change, which represents the observed speed and direction of change in the network's resilience over the monitored period. If the first error resilience rate-of-change exceeds the threshold rate in a negative direction—indicating a faster-than-acceptable decline in resilience—the system flags the situation as a potential risk and may assign a higher likelihood of a network outage. Conversely, if the first rate-of-change is slower or within the acceptable range defined by the threshold, the system considers the network to be operating within safe parameters. This comparison allows the system to proactively identify conditions that could lead to network instability, enabling timely interventions to prevent outages and maintain performance. By using a threshold rate-of-change tied to a critical resilience metric, the system ensures that its analysis is both precise and aligned with the specific tolerances of the network.

At step 410, process 400 (e.g., using one or more components described above) determines a likelihood of a first network outage. For example, the system may determine a first likelihood of a first network outage based on comparing the first error resilience rate-of-change to the threshold error resilience metric. The system may determine the likelihood of a first network outage by analyzing the relationship between the network's error resilience rate-of-change and a predefined threshold error resilience metric. For example, after calculating the first error resilience rate-of-change, the system compares this value to the threshold, which represents the acceptable limits for how quickly the network's resilience can decline without risking a failure. If the rate-of-change exceeds the threshold—indicating a rapid or sustained decrease in resilience—the system assigns a higher likelihood to the possibility of a network outage. This likelihood is determined using predictive models or statistical algorithms that account for historical trends, real-time data, and the severity of the deviation from the threshold. Factors such as the network's current load, redundancy, error rates, and past performance under similar conditions may also influence the calculation. A larger deviation or a prolonged decline in resilience would result in a higher likelihood of outage, while resilience rates-of-change within the threshold range would suggest a lower risk. By quantifying the likelihood of an outage, the system provides actionable insights to network administrators, allowing them to implement preventive measures, such as reallocating resources, adjusting configurations, or addressing underlying issues, to mitigate the risk of disruption. This proactive approach ensures network stability and minimizes the potential impact of outages.

In some embodiments, the system may determine the first likelihood of the first network outage based on comparing the first error resilience rate-of-change to the threshold error resilience metric by training a model to predict a potential error resilience metric based on a given computer network traffic data and a given error resilience metric and inputting the first computer network traffic data and the first error resilience metric into the model. For example, the system may determine the first likelihood of a network outage by comparing the first error resilience rate-of-change to a threshold error resilience metric, leveraging a trained predictive model. The process begins with the system training a model using historical computer network traffic data and corresponding error resilience metrics. This training involves feeding the model data that includes network loads, resource utilization, and calculated error resilience metrics, along with the observed outcomes, such as whether network disruptions or outages occurred under similar conditions. The model learns to identify patterns and relationships between network traffic, resilience metrics, and outage risks. Once the model is trained, the system uses it to predict potential error resilience metrics for new data inputs. To determine the likelihood of a first network outage, the system inputs the first computer network traffic data and the first error resilience metric into the model. The model processes this information to predict a future or potential error resilience metric, considering the current load, available resources, and resilience trends. The system then calculates the first error resilience rate-of-change based on the predicted and observed metrics, representing the speed and direction of change in the network's resilience. This calculated rate-of-change is compared to the threshold error resilience metric, which serves as a benchmark for acceptable network performance. If the rate-of-change deviates significantly from the threshold, indicating a rapid or sustained decline in resilience, the system assigns a higher likelihood to the possibility of a network outage. By incorporating a trained model, the system can account for complex and nonlinear relationships between network conditions and resilience, enabling more accurate predictions and proactive mitigation of potential outages.

In some embodiments, the system may determine the first likelihood of the first network outage based on comparing the first error resilience rate-of-change to the threshold error resilience metric by training a model to predict a potential rate-of-change based on a given current computer network traffic data and a given error resilience metric and inputting the first computer network traffic data and the first error resilience metric into the model. For example, the system may determine the first likelihood of a network outage by comparing the first error resilience rate-of-change to a threshold error resilience metric, using a trained model to predict potential rates-of-change. The process starts with the system training a predictive model using historical data that includes computer network traffic data, error resilience metrics, and observed rates-of-change in resilience. During training, the model learns to identify patterns and relationships between network traffic characteristics (e.g., load, usage patterns, resource availability), resilience metrics, and the corresponding rates-of-change, as well as how these factors relate to network stability or outages. Once trained, the system uses the model to predict a potential rate-of-change in error resilience based on current network conditions. It inputs the first computer network traffic data and the first error resilience metric into the model, which then processes this data to estimate the future rate-of-change. This predicted rate-of-change reflects how quickly the network's resilience might improve or decline given the current conditions. The system then compares this predicted rate-of-change to a predefined threshold error resilience metric, which serves as a benchmark for acceptable network behavior. If the predicted rate-of-change indicates a significant decline in resilience beyond the threshold, the system assigns a higher likelihood to the possibility of a network outage. By incorporating a trained model to predict rates-of-change, the system accounts for complex and dynamic interactions between traffic patterns and resilience metrics, enabling it to anticipate potential vulnerabilities with greater accuracy. This predictive capability allows for proactive measures to mitigate risks and maintain network reliability.

In some embodiments, the system may determine the first likelihood of the first network outage based on comparing the first error resilience rate-of-change to the threshold error resilience metric by training a model to predict a potential network outage based on a given pattern in error resilience rate-of-change and a given threshold error resilience metric, determining a first pattern based on the first error resilience rate-of-change, and inputting the first pattern and the threshold error resilience metric into the model. For example, the system may determine the first likelihood of a network outage by leveraging a trained model to analyze patterns in error resilience rate-of-change and their relationship to a threshold error resilience metric. The process begins with the system training a predictive model using historical data, including patterns in error resilience rate-of-change, corresponding threshold metrics, and observed network outage events. During training, the model learns to recognize specific patterns or trends in the rate-of-change, such as sustained declines, sudden drops, or fluctuating behaviors, that are associated with an increased risk of outages when compared to the threshold error resilience metric. To evaluate the likelihood of the first network outage, the system identifies the first pattern in the current data. It does this by analyzing the first error resilience rate-of-change and determining its shape, direction, and magnitude over time, capturing any distinctive trends or anomalies. The system then inputs this first pattern, along with the threshold error resilience metric, into the trained model. The model processes these inputs to evaluate whether the identified pattern, when compared to the threshold, aligns with conditions that historically led to network outages. Based on the analysis, the model outputs a likelihood score indicating the probability of a network outage occurring. If the first pattern exhibits characteristics such as a rapid decline or prolonged deviation from the threshold, the likelihood score would be higher. By focusing on patterns in the rate-of-change rather than isolated values, the system enhances its ability to detect early warning signs of potential failures, even in complex and dynamic network environments. This approach allows network administrators to proactively address risks and maintain system reliability.

In some embodiments, the system may determine the first likelihood of the first network outage based on comparing the first error resilience rate-of-change to the threshold error resilience metric by training a model to predict a potential time period at which a current error resilience metric corresponds to a threshold error resilience metric based on a given computer network traffic data and a given error resilience metric and inputting the first computer network traffic data and the first error resilience metric into the model. For example, the system may determine the first likelihood of a network outage by training a predictive model to estimate the time period at which a current error resilience metric may reach a threshold error resilience metric, based on current computer network traffic data and resilience metrics. The process begins with the system training a model using historical data that includes computer network traffic patterns, corresponding error resilience metrics, and the time periods during which those metrics approached or crossed threshold values associated with network vulnerabilities or outages. The model learns to recognize how traffic patterns and resilience metrics evolve over time, identifying key indicators that signal when resilience is likely to decline to critical levels. To predict the likelihood of the first network outage, the system inputs the first computer network traffic data and the first error resilience metric into the trained model. The model processes these inputs to forecast the time period at which the current error resilience metric might reach or fall below the threshold error resilience metric. This prediction considers factors such as current load, resource availability, and the rate at which resilience is changing, enabling the model to estimate the time remaining before the threshold is breached. Using this predicted time period, the system calculates the likelihood of an outage by assessing how imminent the breach of the threshold is and how critical the threshold is for network stability. If the model predicts that the error resilience metric will reach the threshold in a short time period or under conditions of heavy load, the system assigns a higher likelihood to the occurrence of a network outage. This approach allows the system to anticipate potential failures, giving administrators time to implement corrective measures and reduce the risk of disruptions.

In some embodiments, the system may generate for display, on a user interface, a prediction for the first network outage based on the first likelihood. For example, the system may generate a prediction for the first network outage and display it on a user interface by analyzing data related to the network's performance, resilience, and potential vulnerabilities. First, the system calculates a likelihood of a network outage occurring, often based on factors such as error resilience metrics, rate-of-change in resilience, historical patterns, current network loads, and detected anomalies. This likelihood, expressed as a probability or confidence level, reflects the system's assessment of the risk of an outage based on observed conditions and predictive models.

Once the first likelihood is determined, the system translates this information into a user-friendly format for display on the interface. The display may include visual elements such as charts, graphs, or color-coded indicators to represent the level of risk. For instance, a rising trend line might illustrate declining error resilience over time, while a red warning symbol could signal a high likelihood of an outage. Additionally, the system may provide context, such as the specific factors contributing to the prediction (e.g., sustained load increases or resource depletion), and recommend preventive actions, like increasing redundancy or reducing network strain.

By presenting this information clearly and interactively, the system enables users to quickly understand the risk of an outage and take proactive measures to mitigate it. This predictive capability is especially valuable for network administrators, as it helps them maintain network stability, prevent disruptions, and optimize resource allocation.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims that follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for predicting network outages based on detected network-wide resilience.
2. The method of any one of the preceding embodiments, further comprising: receiving first computer network traffic data for a first time period and a second time period, wherein the first computer network traffic data for the first time period indicates a first load on a first computer network, and wherein the first computer network traffic data for the second time period indicates a second load on the first computer network; determining a first error resilience metric based on the first load; determining a second error resilience metric based on the second load; determining a first error resilience rate-of-change for the first computer network based on the first error resilience metric and the second error resilience metric; comparing the first error resilience rate-of-change to a threshold error resilience metric; determining a first likelihood of a first network outage based on comparing the first error resilience rate-of-change to the threshold error resilience metric; and generating for display, on a user interface, a prediction for the first network outage based on the first likelihood.
3. The method of any one of the preceding embodiments, wherein determining the first error resilience metric is further based on computer resources available to process network operations through the first computer network.
4. The method of any one of the preceding embodiments, wherein the threshold error resilience metric is determined based on: receiving historical computer network traffic data; determining respective historical error resilience metrics for each of a plurality of historical time periods, wherein each of the respective historical error resilience metrics comprises a respective percentage of network resources available for additional network traffic; determining historical rate-of-changes in the respective historical error resilience metrics over each of the plurality of historical time periods; and determining threshold error resilience metrics corresponding to a given error resilience metric and a given rate-of-change in the given error resilience metric.
5. The method of any one of the preceding embodiments, wherein determining the first likelihood of the first network outage based on comparing the first error resilience rate-of-change to the threshold error resilience metric further comprises: training a model to predict a potential error resilience metric based on a given computer network traffic data and a given error resilience metric; and inputting the first computer network traffic data and the first error resilience metric into the model.
6. The method of any one of the preceding embodiments, wherein determining the first likelihood of the first network outage based on comparing the first error resilience rate-of-change to the threshold error resilience metric further comprises: training a model to predict a potential rate-of-change based on a given current computer network traffic data and a given error resilience metric; and inputting the first computer network traffic data and the first error resilience metric into the model.
7. The method of any one of the preceding embodiments, wherein determining the first likelihood of the first network outage based on comparing the first error resilience rate-of-change to the threshold error resilience metric further comprises: training a model to predict a potential network outage based on a given pattern in error resilience rate-of-change and a given threshold error resilience metric; determining a first pattern based on the first error resilience rate-of-change; and inputting the first pattern and the threshold error resilience metric into the model.
8. The method of any one of the preceding embodiments, wherein determining the first likelihood of the first network outage based on comparing the first error resilience rate-of-change to the threshold error resilience metric further comprises: training a model to predict a potential time period at which a current error resilience metric corresponds to a threshold error resilience metric based on a given computer network traffic data and a given error resilience metric; and inputting the first computer network traffic data and the first error resilience metric into the model.
9. The method of any one of the preceding embodiments, wherein determining the first error resilience metric based on the first load further comprises: determining an amount of excess computer resources available to process network operations through the first computer network; determining a percentage of a total amount of computer resources in the first computer network corresponding to the amount of excess computer resources available to process network operations through the first computer network; and determining the first error resilience metric based on the percentage.
10. The method of any one of the preceding embodiments, wherein determining the first likelihood of the first network outage based on comparing the first error resilience rate-of-change to the threshold error resilience metric further comprises: determining a difference in time between the second error resilience metric and the threshold error resilience metric based on the first error resilience rate-of-change; and using the difference in time to determine the first likelihood.
11. The method of any one of the preceding embodiments, wherein determining the first likelihood of the first network outage based on comparing the first error resilience rate-of-change to the threshold error resilience metric further comprises: determining a difference in time between the first time period, corresponding to the first error resilience metric, and the second time period, corresponding to the second error resilience metric; and using the difference in time to determine the first likelihood.
12. The method of any one of the preceding embodiments, wherein determining the first error resilience rate-of-change for the first computer network based on the first error resilience metric and the second error resilience metric further comprises: determining a first component rate-of-change for the first time period; determining the first error resilience metric based on the first component rate-of-change; determining a second component rate-of-change for the second time period; determining the second error resilience metric based on the second component rate-of-change; determining an aggregate rate-of-change based on the first component rate-of-change and the second component rate-of-change; and using the aggregate rate-of-change to determine the first error resilience rate-of-change.
13. The method of any one of the preceding embodiments, wherein determining the first error resilience rate-of-change for the first computer network based on the first error resilience metric and the second error resilience metric further comprises: determining a third error resilience metric based on a third load for a third time period; accepting the first error resilience metric and the second error resilience metric for use in determining a first trend; rejecting the third error resilience metric for use in determining the first trend; and using the first trend to determine the first error resilience rate-of-change.
14. The method of any one of the preceding embodiments, wherein comparing the first error resilience rate-of-change to the threshold error resilience metric further comprises: determining a threshold error resilience rate-of-change corresponding to the threshold error resilience metric; and using the threshold error resilience rate-of-change to compare to the first error resilience rate-of-change.
15. One or more non-transitory, computer-readable mediums storing instructions that, when executed by a data processing apparatus, cause the data processing apparatus to perform operations comprising those of any of embodiments 1-14.
16. A system comprising one or more processors; and memory storing instructions that, when executed by the processors, cause the processors to effectuate operations comprising those of any of embodiments 1-14.
17. A system comprising means for performing any of embodiments 1-14.

What is claimed is:

1. A system for predicting network outages based on detected network-wide resilience; the system comprising:
one or more processors; and
one or more non-transitory, computer-readable media comprising instructions recorded thereon that when executed by the one or more processors cause operations comprising:
monitoring network operations communicated between a first network device on a first computer network and a second network device on the first computer network over a first time period and a second time period;
determining first computer network traffic data based on monitoring the network operations, wherein the first computer network traffic data for the first time period indicates a first load on a first computer network, and wherein the first computer network traffic data for the second time period indicates a second load on the first computer network, wherein the first load corresponds to a first subset of the network operations processed during the first time period, and wherein the second load corresponds to a second subset of the network operations processed during the second time period;
determining a first error resilience metric based on the first load, wherein the first error resilience metric is based on a first amount of computer resources available for processing additional network operations through the first computer network beyond the first load;
determining a second error resilience metric based on the second load, wherein the second error resilience metric is based on a second amount of computer resources available for processing the additional network operations through the first computer network beyond the second load;
archiving, in a database of historical error resilience metrics, the first error resilience metric as corresponding to the first time period and the second error resilience metric as corresponding to the second time period;
determining a first error resilience rate-of-change for the first computer network based on the first error resilience metric and the second error resilience metric;
comparing the first error resilience rate-of-change to a threshold error resilience metric;
determining a first likelihood of a first network outage based on comparing the first error resilience rate-of-change to the threshold error resilience metric; and
generating for display, on a user interface, a prediction for the first network outage based on the first likelihood.

2. A method for predicting network outages based on detected network-wide resilience, the method comprising:
receiving first computer network traffic data for a first time period and a second time period, wherein the first computer network traffic data for the first time period indicates a first load on a first computer network, and wherein the first computer network traffic data for the second time period indicates a second load on the first computer network;
determining a first error resilience metric based on the first load;
determining a second error resilience metric based on the second load;
determining a first error resilience rate-of-change for the first computer network based on the first error resilience metric and the second error resilience metric;
comparing the first error resilience rate-of-change to a threshold error resilience metric;
determining a first likelihood of a first network outage based on comparing the first error resilience rate-of-change to the threshold error resilience metric; and
generating for display, on a user interface, a prediction for the first network outage based on the first likelihood.

3. The method of claim 2, wherein determining the first error resilience metric is further based on computer resources available to process network operations through the first computer network.

4. The method of claim 2, wherein the threshold error resilience metric is determined based on:
receiving historical computer network traffic data;
determining respective historical error resilience metrics for each of a plurality of historical time periods, wherein each of the respective historical error resilience metrics comprises a respective percentage of network resources available for additional network traffic;
determining historical rate-of-changes in the respective historical error resilience metrics over each of the plurality of historical time periods; and
determining threshold error resilience metrics corresponding to a given error resilience metric and a given rate-of-change in the given error resilience metric.

5. The method of claim 2, wherein determining the first likelihood of the first network outage based on comparing the first error resilience rate-of-change to the threshold error resilience metric further comprises:
training a model to predict a potential error resilience metric based on a given computer network traffic data and a given error resilience metric; and
inputting the first computer network traffic data and the first error resilience metric into the model.

6. The method of claim 2, wherein determining the first likelihood of the first network outage based on comparing the first error resilience rate-of-change to the threshold error resilience metric further comprises:
training a model to predict a potential rate-of-change based on a given current computer network traffic data and a given error resilience metric; and
inputting the first computer network traffic data and the first error resilience metric into the model.

7. The method of claim 2, wherein determining the first likelihood of the first network outage based on comparing the first error resilience rate-of-change to the threshold error resilience metric further comprises:
training a model to predict a potential network outage based on a given pattern in error resilience rate-of-change and a given threshold error resilience metric;
determining a first pattern based on the first error resilience rate-of-change; and
inputting the first pattern and the threshold error resilience metric into the model.

8. The method of claim 2, wherein determining the first likelihood of the first network outage based on comparing the first error resilience rate-of-change to the threshold error resilience metric further comprises:
training a model to predict a potential time period at which a current error resilience metric corresponds to a threshold error resilience metric based on a given computer network traffic data and a given error resilience metric; and
inputting the first computer network traffic data and the first error resilience metric into the model.

9. The method of claim 2, wherein determining the first error resilience metric based on the first load further comprises:
determining an amount of excess computer resources available to process network operations through the first computer network;
determining a percentage of a total amount of computer resources in the first computer network corresponding to the amount of excess computer resources available to process network operations through the first computer network; and
determining the first error resilience metric based on the percentage.

10. The method of claim 2, wherein determining the first likelihood of the first network outage based on comparing the first error resilience rate-of-change to the threshold error resilience metric further comprises:
determining a difference in time between the second error resilience metric and the threshold error resilience metric based on the first error resilience rate-of-change; and
using the difference in time to determine the first likelihood.

11. The method of claim 2, wherein determining the first likelihood of the first network outage based on comparing the first error resilience rate-of-change to the threshold error resilience metric further comprises:
determining a difference in time between the first time period, corresponding to the first error resilience metric, and the second time period, corresponding to the second error resilience metric; and
using the difference in time to determine the first likelihood.

12. The method of claim 2, wherein determining the first error resilience rate-of-change for the first computer network based on the first error resilience metric and the second error resilience metric further comprises:
determining a first component rate-of-change for the first time period;
determining the first error resilience metric based on the first component rate-of-change;
determining a second component rate-of-change for the second time period;
determining the second error resilience metric based on the second component rate-of-change;
determining an aggregate rate-of-change based on the first component rate-of-change and the second component rate-of-change; and
using the aggregate rate-of-change to determine the first error resilience rate-of-change.

13. The method of claim 2, wherein determining the first error resilience rate-of-change for the first computer network based on the first error resilience metric and the second error resilience metric further comprises:
determining a third error resilience metric based on a third load for a third time period;
accepting the first error resilience metric and the second error resilience metric for use in determining a first trend;
rejecting the third error resilience metric for use in determining the first trend; and
using the first trend to determine the first error resilience rate-of-change.

14. The method of claim 2, wherein comparing the first error resilience rate-of-change to the threshold error resilience metric further comprises:
determining a threshold error resilience rate-of-change corresponding to the threshold error resilience metric; and
using the threshold error resilience rate-of-change to compare to the first error resilience rate-of-change.

15. One or more non-transitory, computer-readable media, comprising instructions that, when executed by one or more processors, cause operations comprising:
receiving first computer network traffic data for a first time period and a second time period, wherein the first computer network traffic data for the first time period indicates a first load on a first computer network, and wherein the first computer network traffic data for the second time period indicates a second load on the first computer network;
determining a first error resilience metric based on the first load and a second error resilience metric based on the second load;
determining a first error resilience rate-of-change for the first computer network based on the first error resilience metric and the second error resilience metric;
comparing the first error resilience rate-of-change to a threshold error resilience metric; and
determining a first likelihood of a first network outage based on comparing the first error resilience rate-of-change to the threshold error resilience metric.

16. The one or more non-transitory, computer-readable media of claim 15, wherein determining the first likelihood of the first network outage based on comparing the first error resilience rate-of-change to the threshold error resilience metric further comprises:
training a model to predict a potential error resilience metric based on a given computer network traffic data and a given error resilience metric; and
inputting the first computer network traffic data and the first error resilience metric into the model.

17. The one or more non-transitory, computer-readable media of claim 15, wherein determining the first likelihood of the first network outage based on comparing the first error resilience rate-of-change to the threshold error resilience metric further comprises:
training a model to predict a potential rate-of-change based on a given current computer network traffic data and a given error resilience metric; and
inputting the first computer network traffic data and the first error resilience metric into the model.

18. The one or more non-transitory, computer-readable media of claim 15, wherein determining the first likelihood of the first network outage based on comparing the first error resilience rate-of-change to the threshold error resilience metric further comprises:
training a model to predict a potential network outage based on a given pattern in error resilience rate-of-change and a given threshold error resilience metric;
determining a first pattern based on the first error resilience rate-of-change; and
inputting the first pattern and the threshold error resilience metric into the model.

19. The one or more non-transitory, computer-readable media of claim 15, wherein determining the first likelihood of the first network outage based on comparing the first error resilience rate-of-change to the threshold error resilience metric further comprises:
training a model to predict a potential time period at which a current error resilience metric corresponds to a threshold error resilience metric based on a given computer network traffic data and a given error resilience metric; and
inputting the first computer network traffic data and the first error resilience metric into the model.

20. The one or more non-transitory, computer-readable media of claim 15, wherein determining the first error resilience metric based on the first load further comprises:
determining an amount of excess computer resources available to process network operations through the first computer network;
determining a percentage of a total amount of computer resources in the first computer network corresponding to the amount of excess computer resources available to process network operations through the first computer network; and
determining the first error resilience metric based on the percentage.
